(19) United States
(12) Patent Application Publication
(10) Pub. No.: US 2024/0189745 A1
(43) Pub. Date: Jun. 13, 2024

(54) Filter Sector Assembly of a Disc Filter

(71) Applicant: Valmet Technologies, Inc., Espoo (FI)

(72) Inventor: Janne Laakso, Tampere (FI)

(73) Assignee: Valmet Technologies, Inc., Espoo (FI)

(21) Appl. No.: 18/527,485

(22) Filed: Dec. 4, 2023

(30) Foreign Application Priority Data
Dec. 9, 2022 (FI) 20226090

(51) Int. Cl. B01D 33/15

(52) U.S. Cl. CPC B01D 33/15; B01D 2201/0415; B01D 2201/282

(57) ABSTRACT

A filter sector assembly for a disc filter, which disc filter has a fiber suspension containing bath and a core assembly adapted to rotate on a horizontal axis. The filter sector assemblies are rotatably supported with relation to the bath on the core assembly. The filter sector assemblies are spaced along the core assembly and supported on the core assembly. Each filter sector assembly (50) has two adjacent filter sectors (10A; 10B) releasably fixed to a bent support plate (30). The two adjacent filter sectors (10A; 10B) are attached as a pair of filter sectors (10A; 10B) by fastening the support plate (30) to the core assembly (21; 21A, 21B) of the disc filter.

### CROSS REFERENCES TO RELATED APPLICATIONS

This application claims priority on FI 20226090, filed Dec. 9, 2022, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to filter sectors for filtering fluid and solid mixtures, especially in connection with pulp and fiber web production.

As known from the prior art in fiber web machines, especially in paper and board machines, the fiber web is produced and treated in an assembly formed by a number of apparatuses arranged consecutively in a process line. A typical production and treatment line comprises a forming section comprising a head box and a forming unit and a press section as well as a subsequent drying section and a reel-up. The production and treatment line can further comprise other devices and sections for finishing the fiber web, for example, a size press, a calender, a coating section. The production and treatment line also comprises typically at least one winder for forming customer rolls as well as a roll packaging apparatus.

Before the head box fiber suspensions comprising recycled and/or virgin fibers are treated to be fed into the head box to be used to produce the fiber webs. A treatment system of the pulp suspensions for example comprises a pulping section, a deashing system, a detrashing system, a coarse filtering section, a centrifugal cleaning section, a fractionation section, a fine filtering system, a fiber thickening system and fiber refining systems.

The term “fiber suspensions” means liquids and suspensions, which contain fibers and other occurring ingredients, which are meant to be filtered out. The fibers usually mean recycled cellulose fibers, but also newly produced cellulose fibers can come into question.

It is known from the prior art that different types of disc filters are used to separate liquid from the fiber suspensions. A disc filter typically comprises a fiber suspension containing bath, often referred as a vat, and a, typically tubular, core assembly adapted to rotate on a horizontal axis, and a plurality of filter sectors spaced along the core assembly and supported on the core assembly.

In respect of operation of the disc filter it is important that the filter sectors are properly supported and attached to the core assembly. Occasionally, there might be disturbances in operation of one or more of the filter sectors and a filter sector may also break. Thus, it is also important that the filter sectors are easy to maintain and can be easily replaced. In some known arrangements for filter sectors of disc filters, the maintaining and/or replacing of the filter sectors takes a rather long time, during which the disc filter cannot be operated.

An object of the invention is to create a filter sector assembly in which the disadvantages and problems of prior art are eliminated or at least minimized.

In particular an object of the invention is to create an improved filter sector assembly, in particular in respect of reliable support of the filter sector to the core assembly.

In particular another object of the invention is to create an improved filter sector assembly, in particular in respect of maintenance of the filter sector.

In particular another object of the invention is to create an improved filter sector assembly, in particular in respect of replaceability of the filter sector to the core assembly.

### SUMMARY OF THE INVENTION

According to the invention the filter sector assembly of a disc filter, which disc filter comprises a fiber suspension containing bath, a filter sector assembly rotatably supported with relation to the bath, a core assembly adapted to rotate on a horizontal axis, and a plurality of filter sectors spaced along the core assembly and supported on the core assembly, comprises two adjacent filter sectors and a support plate, and the two adjacent filter sectors are attached as a pair of filter sectors by the support plate to the core assembly of the disc filter.

According to an advantageous feature of the invention the support plate comprises re-openable and re-fastenable attachment means configured to provide fastening between the filter sectors of the filter sector assembly and the core assembly of the disc filter.

According to an advantageous feature of the invention a plurality of the filter sector assemblies, each formed of two adjacent filter sectors supported on the same support plate, are attached on the core assembly of the disc filter.

According to an advantageous feature of the invention at each outer side of the two adjacent filter sectors supported on the same support plate a vertical reinforcing rib is located configured to give further vertical support and sturdiness to the filter sector assembly.

According to an advantageous feature of the invention between the two adjacent filter sectors supported on the same support plate in the filter assembly of the pair of the two adjacent filter sectors a spacer plate is located configured to ensure correct distance between the two adjacent filter sectors of the filter assembly.

According to an advantageous feature of the invention along the top ends of the filter sectors a retainer ring is attached to fasten the top ends of the filter sectors to each other.

According to an advantageous feature of the invention each filter sector comprises a filtering part and, around the filtering part mount frame parts configured to support the filtering part of the filter sector.

According to an advantageous feature of the invention each filter sector comprises a funnel part mounted on the bottom end of the filter sector configured to support and mount the filter sector.

According to an advantageous feature of the invention the funnel part comprises a sector shaped base part and the bottom end of the base part is attached to a support panel and on each side of the base part a side panel is located and configured to provide robustness to the funnel part.

According to an advantageous feature of the invention the support panels of the funnel parts of two adjacent filter sectors are attached to the same support plate, which attach the filter sector assembly formed of the two adjacent filter sectors to the core assembly.

The term “fiber suspensions” means liquids and suspensions, which contain fibers and other occurring ingredients, which are meant to be filtered out. The fibers usually mean recycled cellulose fibers, but also newly produced cellulose fibers can come into question. In this description and the claims, the terms “top” and “bottom” are to be interpreted in view of the disc filter, such that the top indicates the outer part of the disc filter and the bottom indicates the inner part of the disc filter.

By the invention and its advantageous features several advantages are achieved: Reliable support of the filter sectors to the core assembly is achieved by the sturdy support plate supporting two adjacent filter sectors. The attachment means of the support plate provides easy and fast replacing of the filter sectors and easy maintenance of the filter sectors. Thus, also higher strength of the filter sectors during operation of the disc filter is achieved and furthermore better safety for operators is provided.

### BRIEF DESCRIPTION OF THE DRAWINGS

Aspects of the invention, however, together with additional objects and advantages thereof, will be best understood from the following description of some example embodiments when read in connection with the accompanying drawings and in the following the invention is described in more detail referring to the accompanying drawing.

FIG. 1 schematically shows an advantageous example of a filter sector as a schematical assembly drawing.

FIG. 2 very schematically shows an advantageous example of fastening of two adjacent filter sectors by a support plate of a filter sector assembly according to the invention.

FIG. 3 very schematically shows another advantageous example of fastening of two adjacent filter sectors by a support plate of a filter sector assembly according to the invention.

FIG. 4 very schematically shows an advantageous example of a support plate of a filter sector assembly according to the invention.

### DESCRIPTION OF THE PREFERRED EMBODIMENTS

During the course of this description like numbers and signs will be used to identify like elements according to the different views which illustrate the invention. Repetition of some reference signs may have been omitted in the figures for clarity reasons.

FIG. 1 schematically shows an example of a filter sector 10A; 10B comprising a filtering part 11, which is sector shaped. Around the filtering part 11 frame parts 12, 13, 14, 15 are located to be mounted around the filtering part 11 to support the filtering part 11 of the filter sector 10A, 10B. The frame parts comprise two side support bars 12, 14, a bottom support bar 13 and a slightly curved top support bar 15. The filter sector 10A; 10B also comprises a funnel part 16A; 16B, which is to be mounted on the bottom end of the filter sector 10A; 10B to support and to mount the filter sector 10A; 10B. The funnel part 16A; 16B comprises a sector shaped base part 18A; 18B. The bottom end of the base part 18A; 18B is attached to a support panel 17A; 17B, which is substantially rectangular. On each side of the base part 18A, 18B a side panel 19A; 19B is located to provide robustness to the funnel part 16A; 16B.

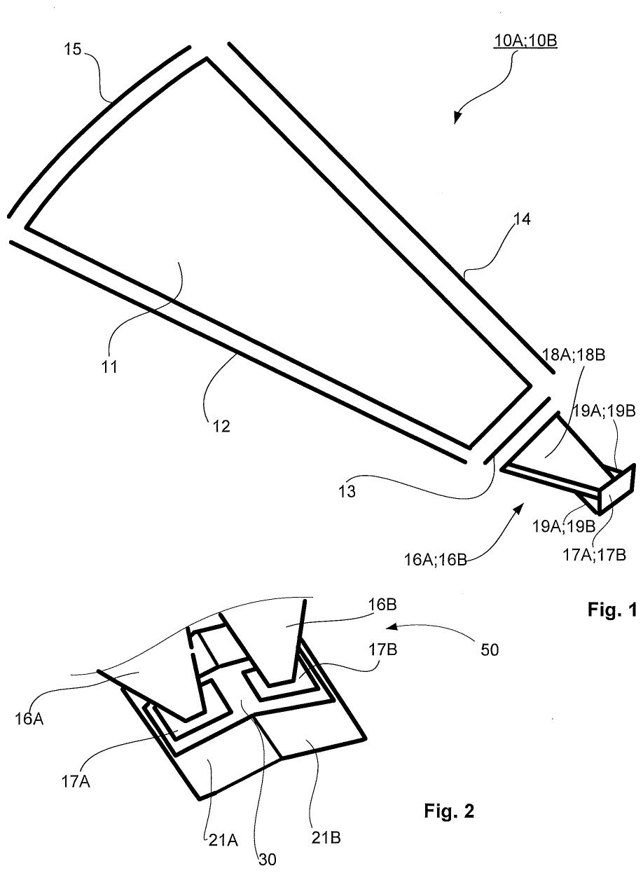

In FIG. 2 is very schematically shown an advantageous example of fastening of two adjacent filter sectors 10A, 10B by a support plate 30 of a filter sector assembly 50 formed of two adjacent filter sectors 10A, 10B. In FIG. 2 only funnel parts 16A,16B with support panels 17A, 17B, correspondingly, of two adjacent filter sectors 10A, 10B are shown. The support panels 17A, 17B of the funnel parts 16A, 16 of two adjacent filter sectors 10A, 10B are attached to the support plate 30, which attaches the two adjacent filter sectors 10A, 10B to the outer surface parts 21A, 21B of a tubular core of a core assembly of a disc filter. In this example the tubular core of the core assembly of the disc filter is formed of an angular structure. The support panels 17A, 17B of the funnel parts 16A, 16 of two adjacent filter sectors 10A, 10B are attached to the support plate 30 by re-openable and re-fastenable attachment means such removable fasteners such as screws 32A, 33A, 32B, 33B (FIG. 4). The funnel parts 16A, 16B have respective attachment openings for the attachment means 32A, 33A, 32B, 33B (FIG. 4). In FIG. 2 only two of the filter sectors 10A, 10B are shown, but it is to be understood that advantageously all filter sectors of the disc filter are attached as pairs of two adjacent filter sectors 10A, 10B by support plates 30 around the outer surface of the disc filter by re-openable and re-fastenable attachment means (not shown). The disc filter comprises a plurality of filter sector assemblies 50, each formed of two adjacent filter sectors 10A, 10B supported on the same support plate 30. Thus, reliable support of the two adjacent filter sectors 10A, 10B to the core assembly is achieved by the sturdy support plate 30 supporting the two adjacent filter sectors 10A, 10B. The re-openable and re-fastenable attachment means 32A, 33A, 32B, 33B of the support plate 30 provide easy and fast replacing of the filter sectors 10A, 10B and easy maintenance of the filter sectors 10A, 10B. Thus, also higher strength of the filter sectors 10A, 10B during operation of the disc filter is achieved and, in addition, better safety for operators is provided.

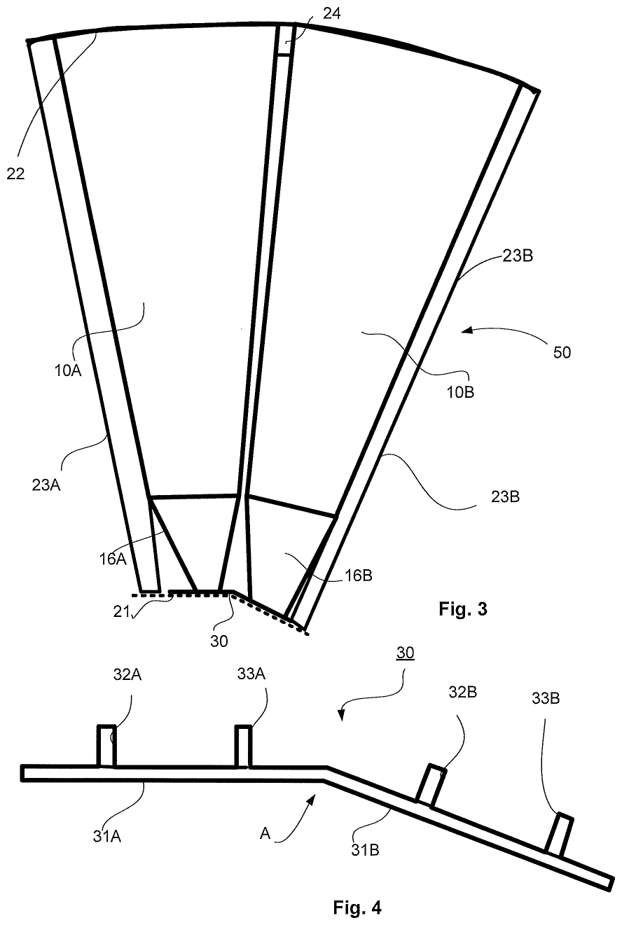

In FIG. 3 is very schematically shown another advantageous example of fastening of two adjacent filter sectors 10A, 10B by a support plate 30 of a filter sector assembly 50 formed of two adjacent filter sectors 10A, 10B. In FIG. 2 only funnel parts 16A, 16B, correspondingly, of two adjacent filter sectors 10A, 10B are shown. As shown in FIG. 3 the funnel parts 16A, 16B of two adjacent filter sectors 10A, 10B are attached to the support plate 30, which attaches the two adjacent filter sectors 10A, 10B to the outer surface 21 of the tubular core of the core assembly of the disc filter. In this example the tubular core of the core assembly of the disc filter is formed of an angular structure. The funnel parts 16A, 16B of two adjacent filter sectors 10A, 10B are attached to the support plate 30 by re-openable and re-fastenable attachment means such as screws 32A, 33A, 32B, 33B (FIG. 4). The funnel parts 16A, 16B have respective attachment openings for the attachment means 32A, 33A, 32B, 33B (FIG. 4). In FIG. 3 only two of the filter sectors 10A, 10B are shown, but it is to be understood that advantageously all filter sectors of the disc filter are attached as pairs of two adjacent filter sectors 10A, 10B by the support plates 30 around the outer surface of the disc filter by re-openable and re-fastenable attachment means (not shown). The disc filter comprises a plurality of filter sector assemblies 50, each formed of two adjacent filter sectors 10A, 10B supported on the same support plate 30. Between the two adjacent filter sector 10A, 10B in the filter assembly of the pair of the two adjacent filter sectors 10A, 10B a spacer plate 24 can be located to ensure the correct distance between the two adjacent filter sectors 10A, 10B. At each outer side of the two adjacent filter sectors 10A, 10B a vertical reinforcing rib 23A, 23B is located to give further vertical support and sturdiness to the filter sector assembly 50. Also, along the top ends of the filter sectors 10A, 10B a retainer ring 22 is attached to fasten the top ends of the filter sectors 10A, 10B to each other and the top ends of the filter sectors 10A, 10B of the filter sector assemblies 50 of the disc filter to each other. Thus, reliable support of the two adjacent filter sectors 10A, 10B to the core assembly is achieved by the sturdy support plate 30 supporting the two adjacent filter sectors 10A, 10B. The re-openable and re-fastenable attachment means 32A, 33A, 32B, 33B of the support plate 30 provide easy and fast replacing of the filter sectors 10A, 10B and easy maintenance of the filter sectors 10A, 10B. Thus, also higher strength of the filter sectors 10A, 10B during operation of the disc filter are achieved and furthermore better safety for operators is provided.

In FIG. 4 is very schematically shown an advantageous example of a support plate 30 of a filter sector assembly 50. One support plate 30 is used to attach two adjacent filter sectors 10A, 10B (such as shown in FIGS. 2-3) to the outer surface of the core assembly of the disc filter. The support plate 30 comprises re-openable and re-fastenable attachment means such as screws 32A, 33A, 32B, 33B to provide fastening between the support panels 17A, 17B of the funnel parts 16A, 16B of the filter sectors 10A, 10B of the filter sector assembly 50 and the core assembly of the disc filter. In FIG. 4 the support plate 30 is shown as a side view and it is to be understood that there may be more than one re-openable and re-fastenable attachment means such as screws 32A, 33A, 32B, 33B in the depth direction of FIG. 4. The support plate 30 of the example of FIG. 4 is provided for an angular outer surface of the tubular core of the core assembly and thus it comprises sections 31A, 31B disposed with respect to each other at an angle A corresponding with the outer surface angles of the tubular core of the core assembly or in an angle A slightly degrees less than the angles of the tubular core of the core assembly.

In the description in the foregoing, although some functions have been described with reference to certain features, those functions may be performable by other features whether described or not. Although features have been described with reference to certain embodiments or examples, those features may also be present in other embodiments or examples whether described or not. Above the invention has been described by referring to some advantageous examples only to which the invention is not to be narrowly limited. Many modifications and alterations are possible within the invention as defined in the following claims.

I claim:

1. A filter sector assembly of a disc filter, which disc filter comprises a fiber suspension containing bath, a filter sector assembly rotatably supported with relation to the bath, a core assembly adapted to rotate on a horizontal axis, and a plurality of filter sectors spaced along the core assembly and supported on the core assembly, wherein the filter sector assembly comprises:
a first filter sector connected to a support plate;
a second filter sector connected to the support plate adjacent the first filter sector; and
wherein the adjacent first filter sector and second filter sector comprise a pair of filter sectors attached by the support plate to the core assembly of the disc filter.

2. The filter sector assembly of claim 1, wherein the support plate comprises re-openable and re-fastenable attachment means configured to provide fastening between the filter sectors of the filter sector assembly and the core assembly of the disc filter.

3. The filter sector assembly of claim 1, wherein a plurality of the filter sector assemblies, each formed of two adjacent filter sectors supported on the same support plate, are attached on the core assembly of the disc filter.

4. The filter sector assembly of claim 1, wherein the first filter sector has a first outer side, and wherein the second filter sector has a second outer side, and further comprising:
a first vertical reinforcing rib connected to the first filter sector first outer side;
a second vertical reinforcing rib connected to the second filter sector second outer side, the first vertical reinforcing rib and the second vertical reinforcing rib being configured to give further vertical support and sturdiness to the filter sector assembly.

5. The filter sector assembly of claim 1 further comprising a spacer plate positioned between the first filter sector and the second filter sector to ensure a correct distance therebetween.

6. The filter sector assembly of claim 1 further comprising a retainer ring attached along top ends of the first filter sector and the second filter sector to fasten the top ends to each other.

7. The filter sector assembly of claim 1 wherein each of the first filter sector and the second filter sector comprises:
a filtering part; and
mount frame parts around the filter part, the mount frame parts configured to support the filtering part.

8. The filter sector assembly of claim 1 wherein each of the first filter sector and the second filter sector has a bottom end, and further comprising a funnel part mounted on each bottom end configured to support and mount the filter sector.

9. The filter sector assembly of claim 8 wherein each funnel part comprises a sector shaped base part having a bottom end which is attached to a support panel and further comprising a side panel on opposite sides of the base part, the side panels configured to provide robustness to the funnel part.

10. The filter sector assembly of claim 9 wherein the support panels of the funnel parts of the adjacent first filter sector and second filter sector are attached to the support plate.

11. A disc filter comprising:
a fiber suspension containing bath;
a core assembly adapted to rotate on a horizontal axis, the core assembly having a plurality of planar outer surface parts, two of which plurality of planar outer surface parts being connected to each other at a first angle which is greater than 90 degrees;
a first filter sector connected to a support plate; and
a second filter sector connected to the support plate adjacent the first filter sector, wherein the adjacent first filter sector and second filter sector comprise a pair of filter sectors attached as a unit by the support plate to the two of the plurality of planar outer surface parts of the core assembly.

12. The disc filter of claim 11 wherein the support plate comprises two sections disposed with respect to each other at a second angle which is greater than 90 degrees, the two sections of the support plate corresponding to the two of the plurality of planar outer surface parts of the core assembly and are releasably attached thereto by releasable fasteners.

13. The disc filter of claim 11 further comprising:
a third filter sector connected to a second support plate; and
a fourth filter sector connected to the second support plate adjacent the third filter sector, wherein the adjacent third filter sector and fourth filter sector comprise an additional filter assembly attached as a unit by the second support plate to planar outer surface parts of the plurality of planar outer surface parts of the core assembly.

14. The filter sector assembly of claim 11 wherein each of the first filter sector and the second filter sector has a bottom end, and further comprising a funnel part mounted on each bottom end.

15. The filter sector assembly of claim 14 wherein each funnel part comprises a sector shaped base part having a bottom end which is attached to a support panel and further comprising a side panel on opposite sides of the base part, the side panels configured to provide robustness to the funnel part.

16. The filter sector assembly of claim 15 wherein the support panels of the funnel parts of the adjacent first filter sector and second filter sector are attached to the support plate.
